(19) United States
(12) Patent Application Publication
(10) Pub. No.: US 2019/0102107 A1
(43) Pub. Date: Apr. 4, 2019

(54) TECHNIQUES FOR BATCH OPERATIONS TO STORAGE DEVICES

(71) Applicant: Intel Corporation, Santa Clara, CA (US)

(72) Inventor: Francesc GUIM BERNAT, Barcelona (ES)

(21) Appl. No.: 15/721,441

(22) Filed: Sep. 29, 2017

(51) Int. Cl. G06F 3/06

(52) U.S. Cl. CPC G06F 3/0659; G06F 3/067; G06F 3/0604

(57) ABSTRACT

Examples include techniques to manage or process batch access operations to storage devices. Examples include receiving a batch access operation request to remotely access storage devices. The batch access operations request included in a fabric packet routed to a target host computing node coupled with the storage devices through a networking fabric. A granted batch access operation request having multiple read/write transactions to or from selected storage devices.

### TECHNICAL FIELD

Examples described herein are generally related to remote access to memory devices by computing nodes coupled with a networking fabric.

### BACKGROUND

Demands by individuals, researchers, and enterprises for increased compute performance and storage capacity of computing devices have resulted in various computing technologies developed to address those demands. For example, compute intensive applications, such as enterprise cloud-based applications (e.g., software as a service (SaaS) applications), data mining applications, data-driven modeling applications, scientific computation problem solving applications, etc., typically rely on complex, large-scale computing environments (e.g., high-performance computing (HPC) environments, cloud computing environments, etc.) to execute the compute intensive applications, as well as store voluminous amounts of data. Such large-scale computing environments can include tens of hundreds (e.g., enterprise systems) to tens of thousands (e.g., HPC systems) of computing nodes connected via high-speed interconnects (e.g., fabric interconnects in a unified fabric).

A sharper focus on resource provisioning, resource management and meeting quality of service (QoS) requirements associated with service level agreements (SLAs) for large-scale computing environments may lead to a closer look at how certain resources are used. An area of focus may be use of disaggregated storage or memory devices that may be remotely accessed by computing nodes. These disaggregated storage or memory devices may include non-volatile and/or volatile types of memory that may be accessed through a memory controller. In some examples, the memory controller and the disaggregated storage or memory devices may be arranged to operate according to one or more standards or specifications such as, but not limited to, the Non-Volatile Memory Express (NVMe) Base Specification, revision 1.3, published in May 2017 (“NVM Express base specification” or “NVMe base specification”). For these examples, storage or memory devices capable of being accessed using NVMe base specification protocols may be referred to as “NVMe devices”.

NVMe devices may be remotely accessed by computing nodes interconnected via one or more types of unified fabric that may be referred to as “networking fabrics” that may use one or more communication protocols to exchange information or data. These networking fabrics may be capable of using a common architecture that supports use of NVMe base specification storage protocols to remotely access NVMe devices. Example communication protocols used by these networking fabrics may include, but are not limited to, Fibre Channel, InfiniBand, Remote Direct Memory Access (RDMA) over Converged Ethernet (RoCE), Internet Wide Area RDMA Protocol (iWARP) or transmission control protocol (TCP) communication protocols. The common architecture used by these types of networking fabrics may be based on one or more standards or specifications such as, but not limited to, the NVM Express over Fabrics (NVMeoF) Specification, revision 1.0, published in June 2016 (“NVMeoF specification”). Memory controllers hosted by computing nodes coupled with networking fabrics arranged to operate according to the NVMeoF specification to allow for remote access to NVMe devices may be referred to as “NVMeoF controllers”.

### BRIEF DESCRIPTION OF THE DRAWINGS

FIG. 1 illustrates an example first system.

FIG. 2 illustrates an example target host computing node.

FIG. 3 illustrates an example portion of the first system.

FIG. 4 illustrates an example format.

FIG. 5 illustrates an example communication flow.

FIG. 6 illustrates an example batch management table.

FIG. 7 illustrates an example batch buffer.

FIG. 8 illustrates an example process.

FIG. 9 illustrates an example block diagram for an apparatus.

FIG. 10 illustrates an example of a logic flow.

FIG. 11 illustrates an example of a storage medium.

FIG. 12 illustrates an example computing platform.

### DETAILED DESCRIPTION

In some examples, an area of focus for large-scale computing environments may be how remote access to disaggregated storage or memory devices may be managed most effectively. These disaggregated storage or memory devices may include NVMe devices that may be remotely accessible through an NVMeoF controller hosted by a computing node coupled with multiple other computing nodes via a networking fabric using a common architecture defined by the NVMeoF specification. In current implementations involving a common networking fabric architecture based, at least in part, on the NVMeoF specification, read/write requests from networking nodes may be generated to remotely access NVMe devices through an NVMeoF controller. The source or requester generating these read/write requests may be referred to as “client computing nodes” or “requesting computing nodes”.

According to some example implementations involving a common networking fabric based, at least in part, on the NVMeoF specification, client computing nodes may have computing workloads that may involve access requests to NVMe devices that may vary as these computing workloads go through multiple phases. For example, a compute intensive phase involving less access requests to NVMe devices or a read/write phase involving increased access requests to NVMe devices. Depending on a nature or priority of a particular phase of a computing workload, performance of NVMe devices in fulfilling access requests may be more or less critical to the computing workload meeting operation requirements associated with service level agreements (SLAs) or quality of service (QoS) requirements. Also, execution of a first computing workload may have a higher priority compared to execution of a second computing workload. An NVMeoF controller that manages access to NVMe devices may have improved transaction scheduling for access requests received from client computing nodes if the NVMeoF controller is made aware of such phases of a given computing workload and its relative priority to other computing workloads. The NVMeoF controller may use this awareness to batch access requests of a given phase or operation of a computing workload to a reserved set of NVMe devices in order to improve transaction scheduling.

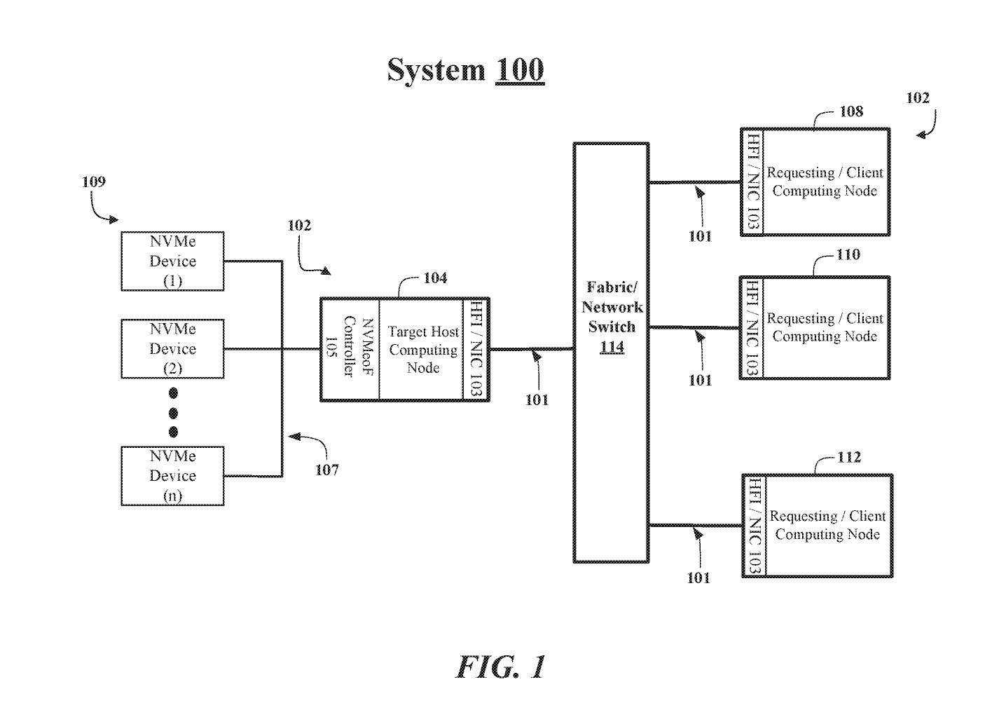

FIG. 1 illustrates an example system 100. In some examples, system 100 may represent at least a portion of a data center, a high performance computing (HPC) network, a telecommunications core network, an enterprise network or cloud-based distributed network. As shown in FIG. 1, computing nodes 102 may include a target host computing node 104 as well as multiple requesting/client computing nodes 108, 110 and 112. Computing nodes 102 may separately be communicatively coupled to a fabric/network switch 114 via individual fabric links 101. It should be appreciated that fabric/network switch 114 may be capable of receiving and forwarding network traffic (e.g., fabric packets, messages, datagrams, etc.) from computing nodes 102 coupled via fabric links 101. As described more below, each computing node 102 may include a host fabric interface (HFI)/network interface card (NIC) 103. HFI/NIC 103 may include communication circuitry and/or communication logic to enable computing nodes 102 to communicatively couple via fabric links 101 routed through fabric/network switch 114 and to facilitate receiving or transmitting of network traffic routed through fabric/network switch 114 and over fabric links 101.

In some examples, as shown in FIG. 1, target host computing node 104 may include an NVMeoF controller 105. As described more below, NVMeoF controller 105 may include logic and/or features capable of facilitating batch access operations to selected NVMe devices from among NVMe devices 109. NVMe devices 109 are shown in FIG. 1 as NVMe device (1) through NVMe device (n) that may be coupled via links 107. For these examples, the “nth” NVMe device of NVMe devices 109 may represent a positive integer and designates one or more additional NVMe devices 109. Also, links 107 may be configured to operate according to the NVMe base specification to access NVMe devices 109.

According to some examples, NVMe devices 109 may serve as disaggregated storage resources that may be remotely accessible to requesting/client computing nodes 108, 110 or 112. For these examples, this remote access may be facilitated by NVMeoF controller 105 that is configured to operate according to the NVMeoF specification. Also, fabric links 101, fabric/network switch 114 and HFI/NIC 103 included in computing nodes 102 may be configured to operate using various types of communication protocols including, but not limited to, Fibre Channel, InfiniBand, RoCE, iWARP or TCP communication protocols as well as operating according to the NVMeoF specification to remotely access NVMe devices 109 via fabric links 101.

In some examples, NVMeoF controller 105 may receive access requests to read or write data to NVMe devices 109 that may include batch operations. These access requests may have originated from requesting/client computing nodes 108, 110 or 112 and may have been routed to target host computing node 104 via fabric links 101 through fabric/network switch 114. As described more below, logic and/or features of NVMeoF controller 105 may be capable of managing batch operations to one or more NVMe devices from among NVMe devices 109 based on access requests submitted by respective requesting/client computing nodes 108, 110 or 112.

According to some examples, NVMe devices 109 may include storage devices such solid state drives (SSDs) or other types of storage devices that may include non-volatile and/or volatile types of memory. Volatile types of memory may be memory whose state (and therefore the data stored on it) is indeterminate if power is interrupted. Non-volatile types of memory may refer to memory whose state is determinate even if power is interrupted. Dynamic volatile memory requires refreshing the data stored in this type of memory to maintain state. One example of dynamic volatile memory includes DRAM, or some variant such as synchronous DRAM (SDRAM). In addition to, or alternatively to, volatile types of memory included in NVMe device 109, non-volatile types of memory may be included in memory device(s) 109. According to some examples, non-volatile types of memory may include byte or block addressable types of non-volatile memory having a 3-dimensional (3-D) cross-point memory structure that includes chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), anti-ferroelectric memory, resistive memory including the metal oxide base, the oxygen vacancy base and the conductive bridge Random Access Memory (CB-RAM), a spintronic magnetic junction memory, a magnetic tunneling junction (MTJ) memory, a Domain Wall (DW) and Spin Orbit Transfer (SOT) memory, a thiristor based memory, a magnetoresistive random access memory (MRAM) that incorporates memristor technology, spin transfer torque MRAM (STT-MRAM), or a combination of any of the above.

In some examples, computing nodes 102 may be embodied as any type of compute and/or storage device that is capable of performing the functions described herein, such as, without limitation, a server (e.g., stand-alone, rack-mounted, blade, etc.), a network appliance (e.g., physical or virtual), a web appliance, a distributed computing system, and/or a multiprocessor-based system.

It should be appreciated that, in other examples, there may be any number of computing nodes 102 (e.g., other target host computing nodes 104, other requesting/client computing nodes 108, 110, 112, etc.) coupled to fabric/network switch 114 or another fabric switch similar to fabric/network switch 114 in system 100. Accordingly, there may be multiple fabric switches in other examples. It should be further appreciated that, in such examples, multiple fabric switches may be connected, or daisy chained, to each other.

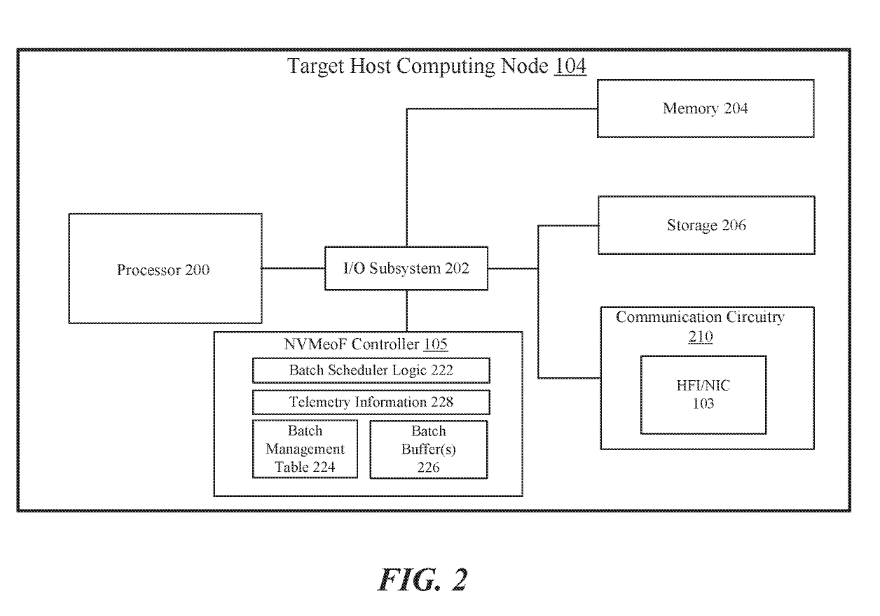

FIG. 2 illustrates an example block diagram of target host computing node 104. In some examples, as shown in FIG. 2, target host computing node 104 includes a processor 200, an input/output (I/O) subsystem 202, memory 204, storage 206, communication circuitry 210 and NVMeoF controller 105. Of course, it should be appreciated that one or more of the computing nodes 102 may include other or additional components, such as those commonly found in a computing device (e.g., peripheral devices, other processing/storage hardware, etc.), in other examples. Additionally, in some examples, one or more of the components shown in FIG. 2 may be incorporated in, or otherwise form a portion of, another component. For example, portions of memory 204 of target host computing node 104 may be incorporated in processor 200 (e.g., as cache memory) or incorporated in NVMeoF controller 105. Further, in some examples, one or more of the illustrative components may be omitted from the target host computing node 104 or added to target host computing node 104. For example, although target host computing node 104 is shown as including a single processor 200, the target host computing node 104 may include a greater number of processors in other examples.

According to some examples, processor 200 may be embodied as any type of multi-core processor capable of performing the functions described herein, such as, but not limited to, a single physical multi-processor core chip, or package. In some examples, processor core(s) of processor 200 may be separately embodied as an independent logical execution unit capable of executing programmed instructions. These processing core(s) may include a portion of cache memory (e.g., an L1 cache) and functional units usable to independently execute programs or threads. In some examples, processor 200 may be connected to a physical connector, or socket, on a motherboard (not shown) of the target host computing node 104 that is configured to accept a single physical processor package (i.e., a multi-core physical integrated circuit).

In some examples, memory 204 may be embodied as any type of volatile or non-volatile memory or data storage device capable of performing the functions described herein. In operation, memory 204 may store various data and software used during operation of the target host computing node 104, such as operating systems, applications, programs, libraries, and drivers. Memory 204 may be communicatively coupled to processor 200 or NVMeoF controller 105 via I/O subsystem 202, which may be embodied as circuitry and/or components to facilitate input/output operations with processor 200, NVMeoF controller 105, memory 204, or other components of target host computing node 104. For example, I/O subsystem 202 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some examples, I/O subsystem 202 may form a portion of a SoC and may be incorporated, along with one or all of processor 200, memory 204, NVMeoF controller 105 and/or other components of target host computing node 104, on a single integrated circuit chip.

According to some examples, storage 206 may be composed of any type of storage device or devices configured for short-term or long-term storage of data such as, for example, memory devices and circuits, memory cards, hard disk drives, solid-state drives, or other types of storage devices. It should be appreciated that storage 206 and/or the memory 204 (e.g., the computer-readable storage media) may store various data as described herein, including operating systems, applications, programs, libraries, drivers, instructions, etc., capable of being executed by a processor (e.g., processor 200) of target host computing node 104.

In some examples, communication circuitry 210 may include any communication circuit, device, or collection thereof, capable of enabling wireless and/or wired communications between target host computing node 104 and other computing devices (e.g., a requesting/client computing node 108, fabric/network switch 114, etc.). Communication circuitry 210 may be configured to use one or more communication technologies associated with networking fabrics including, but not limited to, Fibre Channel, InfiniBand, RoCE, iWARP or TCP communication protocols. Communication circuity 210 may also capable of using other types of communication technologies in addition to those associated with networking fabric communication protocols to enable wireless and/or wired communications between target host computing node 104 and other computing devices (e.g., Internet Protocol (IP), Ethernet, Bluetooth®, Wi-Fi®, WiMAX, LTE, 5G, etc.).

According to some examples, as shown in FIG. 2, communication circuitry 210 may include HFI/NIC 103. HFI/NIC 103 may be composed of one or more add-in-boards, daughter cards, NICs, controller chips, chipsets, or other devices that may be used by target host computing node 104. For example, HFI/NIC 103 may be integrated with processor 200, embodied as an expansion card coupled to I/O subsystem 202 over an expansion bus (e.g., PCI Express (PCIe)), part of an SoC, or included on a multichip package that may contain one or more processors besides processor 200. In some examples, functionality of HFI/NIC 103 may be integrated into one or more components of target host computing node 104 at the board level, socket level, chip level, and/or other levels. HFI/NIC 103 may include logic and/or features to facilitate exchanges of data/messages between components (e.g., NVMeoF controller 105) of target host computing node 104 and requesting/client computing nodes received or transmitted over fabric links of a fabric network in order for the requesting/client computing nodes to remotely access one or more NVMe devices coupled with target host computing node 104. For example, facilitating the exchange of data/messages received in one or more fabric packets from requesting/client computing nodes 108, 110 or 112 routed via fabric links 101 through fabric/network switch 114 to target host computing node 104 coupled with NVMe devices 109 as shown in FIG. 1 for system 100. The one or more fabric packets may be arranged or exchanged according to communication protocols including, but not limited to, Fibre Channel, InfiniBand, RoCE, iWARP or TCP communication protocols and/or according to the NVMeoF specification.

In some examples, as shown in FIG. 2 and also shown in FIG. 1, target host computing node 104 also includes NVMeoF controller 105. As mentioned briefly above for FIG. 1, NVMeoF controller 105 may include logic and/or features capable of facilitating or managing batch access operations to selected NVMe devices from among NVMe devices 109. According to some examples, as shown in FIG. 2, the logic and/or features capable of facilitating or managing batch access operations to the selected NVMe devices may include, but are not limited to, a batch scheduler logic 222, a batch management table 224, one or more batch buffer(s) 226 or telemetry information 228. According to some examples, NVMeoF controller 105 may receive batch access operation requests included in fabric packets or fabric messages received and/or processed by HFI/NIC 103 to read or write data to NVMe devices 109 via batch operations. For these examples, the batch access operation requests may have originated from requesting/client computing nodes 108, 110 or 112 and routed to target host computing node 104 via fabric links 101 through fabric/network switch 114. At least some of the batch access operation requests may be associated with random access patterns hereinafter referred to as “random streams”. These random streams may read/write data from/to random NVMe device memory addresses at one or more NVMe devices of NVMe devices 109. At least some of the individual batch access operation request may be associated with sequential access patterns hereinafter referred to as “sequential streams”. These sequential streams may read/write data from/to sequential NVMe device memory addresses at one or more NVMe devices of NVMe devices 109.

According to some examples, batch scheduler logic 222 may be capable of managing batch access operations. As described more below, batch scheduler logic 222 may schedule read/write transactions associated with batch access operation from requesting/client computing nodes 108, 110 or 112 to one or more NVMe devices from among NVMe devices 109 using knowledge about NVMe devices (e.g., read/write sequential stream peak memory bandwidth, read/write random stream peak bandwidth or other information). Batch scheduler logic 222 may indicate to a requesting/client computing node whether or not a particular batch access operation can be implemented as requested or needs to be terminated or ended before completion of the batch access operation. Batch scheduler logic 222 may also indicate to the requesting/client computing node a need to throttle a given batch access operation due to unexpected changes in access request patterns for the given batch access operation. For example, sequential streams were expected during the given batch access operation but random streams were actually received from the requesting/client computing node. The random streams may negatively impact performance of the one or more NVMe devices for other batch access operations and thus may need to be throttled to reduce performance impacts to other batch access operations to the one or more NVMe devices.

According to some examples, batch scheduler logic 222 may be implemented by an field programmable gate array (FPGA) or application specific integrated circuit (ASIC) located at or coupled with NVMeoF controller 105. Alternatively, batch scheduler logic 222 may use one or more algorithms implemented by an FPGA or ASIC to schedule batch access operations. FPGA implementations may allow for greater flexibility in programming or reprogramming batch scheduler logic 222 or algorithms used by batch schedule logic 222 in order to adjust to changing conditions or requirements (e.g., changing SLA or QoS requirements).

In some examples, as described more below, batch management table 224 may include information used by batch scheduler logic 222 to manage batch access operations. As described more below, batch management table 224 may include various table entries that include information for monitoring and/or managing one or more batch access operations that may be mapped to one or more NVMe devices from among NVMe devices 109.

According to some examples, batch buffer(s) 226 may be arranged to at least temporarily store pending transactions associated with active batch access operations. The temporarily stored pending transactions may include payloads of data received from or destined to requesting/client computing nodes as part of respective batch access operations. Batch buffer(s) 226 may include volatile or non-volatile types of memory accessible to logic and/or features of NVMeoF controller 105 (e.g., part of memory 204) or included as part of NVMeoF controller 105 (e.g., on-die memory—not shown).

In some examples, telemetry information 228 may include telemetry information obtained from selected NVMe devices 109 during batch access operations. For these examples, real-time metrics such as, but not limited to, memory bandwidth (BW) or input/outputs per second (IOPs) may be tracked or monitored during batch access operations to determine whether target metrics for these batch access operations are being met. Different batch access operations may have different target metrics and the real-time information may be used to provide feedback to respective requesting/client computing nodes that respective target metrics are/were being met during respective batch access operations.

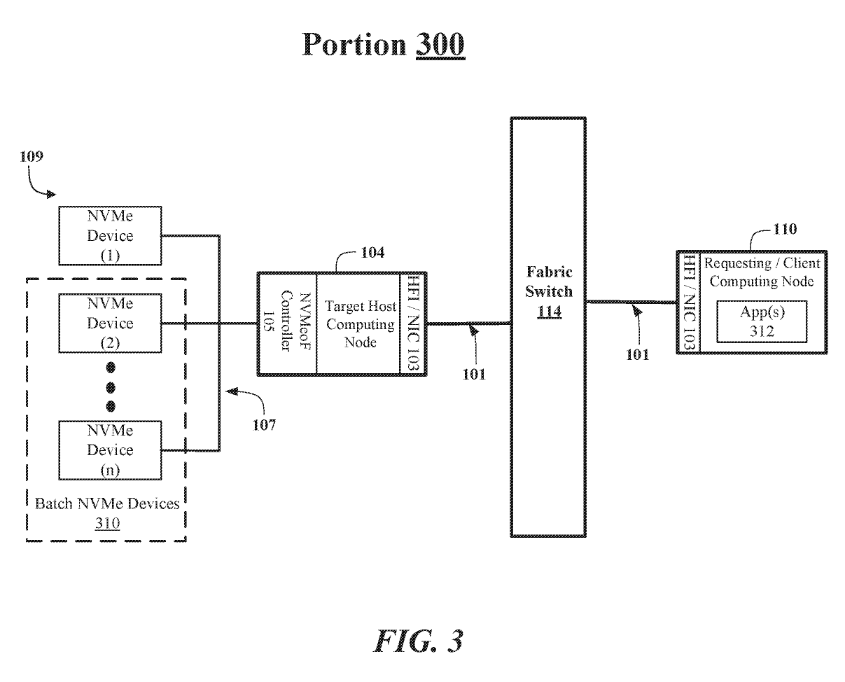

FIG. 3 illustrates an example portion 300. In some examples, as shown in FIG. 3, portion 300 includes elements of system 100 shown in FIG. 1 such as requesting/client computing node 110, fabric/network switch 114, target host computing node 104 and NVMe devices 109. For these examples, one or more applications (App(s)) 312 hosted by requesting/client computing node 110 may have a need for and/or request one or more batch access operations to read/write data to at least one NVMe device of NVMe devices 109. As described more below, logic and/or features of NVMeoF controller 105 hosted by target host computing node 104 may select and reserve one or more NVMe devices of NVMe devices 109 to fulfill the one or more batch access operations. In some examples, the one or more selected NVMe devices are included in the dashed-line box shown in FIG. 3 and identified as batch NVMe devices 310.

According to some examples, selection of the one or more reserved NVMe devices may be contingent on whether adequate memory bandwidth or other types of metrics (e.g., IOPs) can be met by the selected NVMe devices included in batch NVMe devices 310. The logic and/or features of NVMeoF controller 105 may deny or reject a request for a batch access operation if adequate memory bandwidth is not available or other types of metrics cannot be met. For these examples, if adequate memory bandwidth is available or other types of metrics can be met, as described more below, the logic and/or features of NVMeoF controller (e.g., batch scheduler logic 222) may manage respective batch access requests based on information received from requesting/client computing node 110 as well as information related to a status of pending transactions for respective batch access requests.

In some examples, App(s) 312 may be utilized at requesting/client computing node 110 to fulfill one or more computing workloads that may be in a phase of execution or operation that requires an increased level of access to NVMe devices 109 compared to other phases. For these examples, requesting/client computing node 110 may send the request for batch access operations responsive to this increased level of access to NVMe devices 109. Requesting/client computing node 110 may also indicate a nature or priority of this phase in terms of being more or less critical to the computing workload meeting one or more SLA or QoS requirements. For example, the batch access operations may indicate a high priority if the batch access operations are critical to meeting the one or more SLA or QoS requirements or a low priority if the batch access operations are not critical to meeting the one or more SLA or QoS requirements. The logic and/or features of NVMeoF controller 105 may use this priority information to manage the batch access operation in relation to other active batch access operations that may also include the use of batch NVMe devices 310

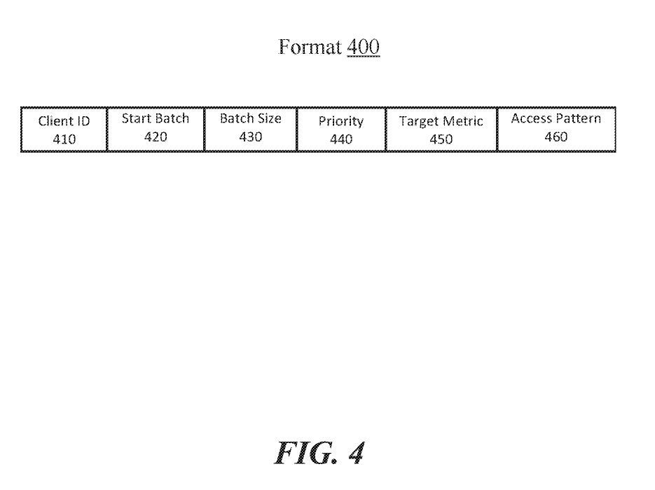

FIG. 4 illustrates an example format 400. In some examples, example format 400 may represent example fields included in a fabric message or packet having a batch access operation request that was sent by a requesting/client computing node to a target host computing node. As shown in FIG. 4, example format 400 includes client ID 410, start batch 420, batch size 430, priority 440, target metric 450 and access pattern 460. For these examples, client ID 410 may indicate the identifier for the requesting/client computing node (e.g., 110). Start batch 420 may indicate that batch access operation is being requested. Batch size 430 may indicate a size of the requested batch operation. The size may be based on the expected number of read/write operations that may be needed during the batch access operation and/or may be based on an expected total amount of data (e.g., in bytes) that is to be read from or written to NVMe devices during a batch access operation. Priority 440 may indicate a priority for a phase of operation associated with the batch access operation. Target metric 450 may indicate one or more target metrics that may need to be met during the batch access operation. For example, a memory bandwidth target metric or an IOPs target metric. Access pattern 460 may indicate whether access requests to NVMe device(s) during the batch access operation have a sequential or have random access patterns (e.g., are composed of sequential or random streams).

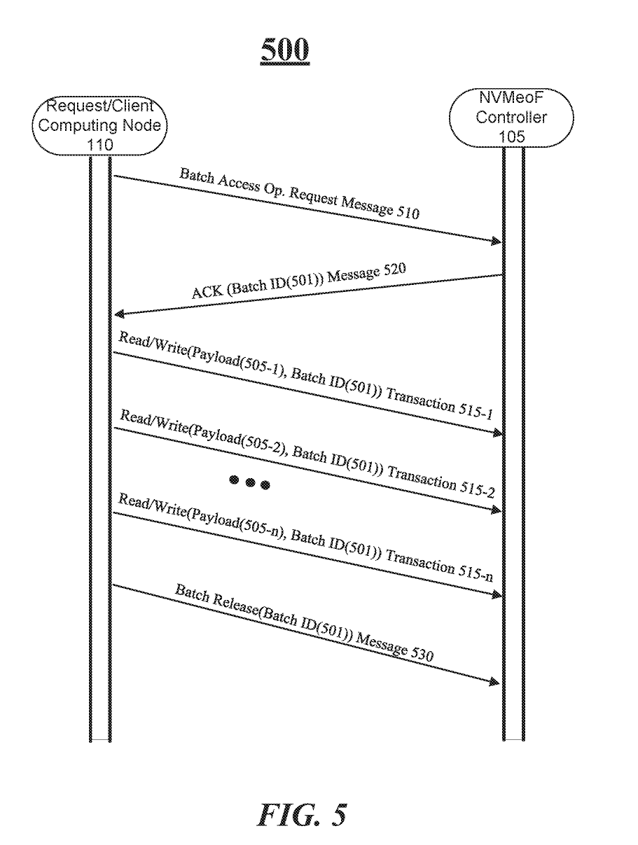

FIG. 5 illustrates an example communication flow 500. According to some examples, communication flow 500 may be an example of how logic and/or features of NVMeoF controller 105 may receive a batch access operation request from request/client computing node 110 and then fulfill or process transactions of batch access operation. For these examples, elements of system 100 as shown in FIG. 1 or FIG. 3 may implement at least portions of communication flow 500. Also, example format 400 as shown in FIG. 4 may be used in portions of communication flow 500. Examples are not limited to elements of system 100 or to use of format 400 when implementing communication flow 500.

According to some examples, as shown in FIG. 5, communication flow 500 shows that a batch access operation request message 510 may be sent from requesting/client computing node 110 to NVMeoF controller 105. For these examples, batch access operation request message 510 may be included in a fabric packet set by requesting/client computing node 110 to target host computing node 104. Batch access operation request message 510 may include the example fields of example format 400 as shown in FIG. 4 and mentioned above. For example, batch access operation request message 510 may indicate a client ID (e.g., 110), that a batch access operation request is being made, a size of the requested batch operation (e.g., 10 gigabytes (GB)), a priority (e.g., high, medium, low), a target metric (e.g., 250 megabytes per second (MB/sec)) or pattern (e.g., random or sequential stream).

Communication flow 500 then shows that NVMeoF controller 105 may accept (ACK) the batch access operation request included in batch access operation request message 510 by sending an ACK message 520 that include a batch ID 501. In some examples, batch ID 501 may be a batch identifier generated in response to accepting the batch access operation request and may be used by both requesting/client computing node 110 and NVMeoF controller 105 to manage batch access operations. For these examples, NVMeoF controller 105 may generate ACK message 520 if selected one or more NVMe devices from among NVMe devices 109 can meet the target metrics indicated in batch access operation request message 510 or has an indicated access pattern such as a sequential access pattern that may facilitate the meeting of the target metric(s).

Communication flow 500 then shows that requesting/client computing node 110 may send multiple read/write transactions 515 for processing by NVMeoF controller 105. In some examples, read/write transaction 515 may include separate payloads 505 (if write transactions) and batch ID 501. For example, read/write transaction 515-1 may include payload 505-1 and batch ID 501, read/write transaction 515-2 may include payload 505-2 and batch ID 501, read/write transaction 515-n may include payload 505-n and batch ID 501.

Communication flow 500 then shows that a batch release message 530 is sent from requesting/client computing node 110 to NVMeoF controller 105 that includes batch ID 501. In some alternative examples, rather than send a separate message, requesting/client computing node 110 may include an indication in the last read/write transaction that it is the last read/write transaction of batch ID 501 and this may serve as a batch release message.

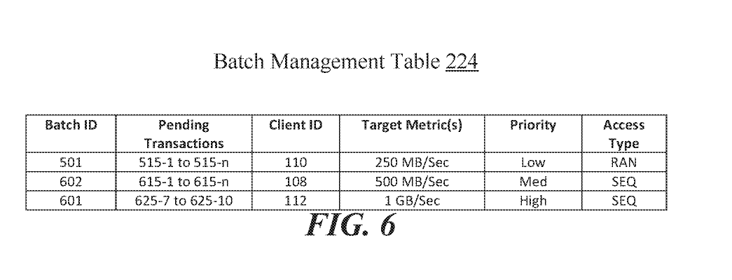

FIG. 6 illustrates an example batch management table 224. In some examples, as shown in FIG. 6, batch management table 224 includes information such as batch ID, pending transactions, client ID, target metric(s), priority or access type for active batch access operations. In some examples, batch management table 224 may be maintained in a data structure (e.g., a lookup table) stored in a memory maintained at NVMeoF controller 105 and accessible to batch scheduler logic 222. As briefly mentioned above, batch schedule logic 222 may use information included in batch management table 224 to process read/write transactions of one or more batch access operations that may be mapped to one or more batched NVMe devices from among NVMe devices 109 (e.g., batched NVMe devices 310).

According to some examples, batch ID information may include an identifier assigned to each entry in batch management table 224 that corresponds to requested batch access operations accepted by NVMeoF controller 105 for accessing the one or more batched NVMe devices. Pending transactions may include information to indicate write/read transactions that may be at temporarily stored in one or more buffers (e.g., in batch buffer(s) 226)) maintained at or accessible to NVMeoF controller 105.

In some examples, each entry in batch management table 224 may also have client ID information associated with respective batch IDs. The client ID information may include an identifier for respective requesting/client computing nodes that have requested and have been granted batch access operations. For example, client IDs associated with requesting/client computing nodes 108, 110 and 112 are shown in FIG. 3. For simplicity purposes, requesting/client computing nodes 108, 110 and 112 are given numbers related to those shown in FIG. 1. Examples are not limited to 3-digit client IDs.

According to some examples, batch management table 224 may include target metric(s) information to indicate one or more target metrics that may need to be met during batch access operations for respective batch IDs. Batch management table 224 may also include priority information for respective batch access operations. The priority information may be based, at least in part, on service level agreements (SLAs) or quality of service (QoS) requirements that may need to be met by for computing workloads executed by requesting/client computing nodes when accessing NVMe devices 109. Batch IDs having high priorities (e.g., 610) may have SLAs or QoS requirements that require a relatively low latency or higher memory bandwidth for accessing NVMe devices 109 during a given phase of a computing workload. Meanwhile, batch IDs having lower priorities (e.g., 501 or 602) may have less restrictive SLAs or QoS requirements that may require a best effort or allow for a relative high latency or lower memory bandwidth for accessing NVMe devices 109 during a given phase of a computing workload. In some examples, batch IDs having higher priorities (e.g., 601) may have pending transactions scheduled ahead of batch IDs having lower priorities. For examples, pending transactions for batch ID 601 may be scheduled ahead of pending transactions for batch IDs 602 and 501 based on the high priority for batch ID 601.

In some examples, batch management table 224 may also indicate access types for the batch access operations. Access types may indicate either random (RAN) or sequential (SEQ) to indicate random or sequential access patterns. This information may be used to schedule random types together (e.g., to shared NVMe devices) and to separate sequential types to dedicated NVMe devices to allow batch access operations with sequential streams to obtain higher memory bandwidths.

In some examples, the target metric(s) and priority information may have been indicated in a batch access operation request message sent from a requesting/client computing node as mentioned above for FIG. 5. For example, batch access operation request message 510 indicated target metric(s) of 250 Mb/sec and a low priority for batch access operations to NVMe devices 109.

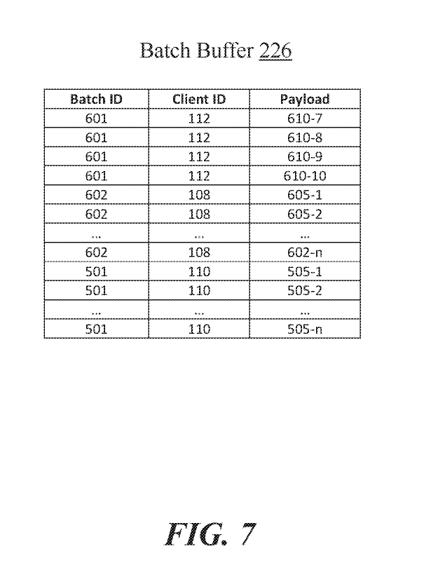

FIG. 7 illustrates an example batch buffer 226. In some examples, batch buffer 226 may include batch and client IDs as well as payloads for pending transactions. For example, as shown in FIG. 7, payloads for batch IDs 601, 501 and 602 from respective client IDs 112, 110 and 108 may be at least temporarily stored in batch buffer 226 before being written to NVMe devices 109. According to some examples, payloads of pending transactions may be scheduled for processing by NVMeoF controller 105 based, at least in part, on priorities indicated in batch management table 224 for a given batch ID. For example, batch ID 601 has a high priority according to batch management table 244 and payloads of pending transactions for batch ID 601 may be scheduled for processing ahead of payloads of pending transactions for batch IDs 602 and 501. Also, batch ID 602 has a medium priority according to batch management table 244 and payloads of pending transactions for batch ID 602 may be scheduled for processing ahead of payloads of pending transactions for batch ID 501 that has a low priority.

According to some examples, scheduling of high priority payloads first may be illustrated by payloads for batch ID 601 being shown in FIG. 7 as the top payloads in batch buffer 226 and the payloads for batch ID 501 being shown in FIG. 7 as the bottom payloads in batch buffer 226. Examples, are not limited to this type of positional scheduling of payloads temporarily stored to batch buffer 226.

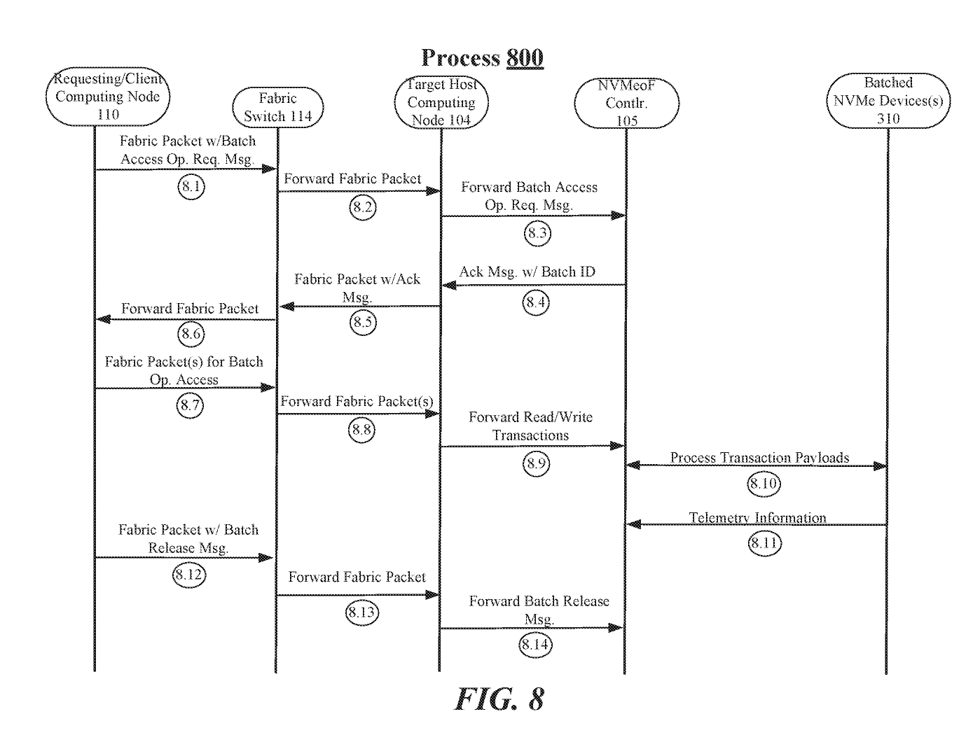

FIG. 8 illustrates an example process 800. According to some examples, process 800 may be an example of how logic and/or features of NVMeoF controller 105 may receive a batch access operation request from request/client computing node 110 and then fulfill the batch access operation. For these examples, elements of system 100 as shown in FIG. 3 or elements of target host computing node 104 as shown in FIG. 2 may implement at least portions of process 800. Also, example format 400 as shown in FIG. 4 or batch management table 224 as shown in FIG. 6 may be used to implement at least portions of process 800. Examples are not limited to elements of system 100 or target host computing node 104 implementing process 800 or to use of batch management table 224 or format 400 when implementing process 800.

Beginning at process 8.1 (Fabric Packet(s) w/Batch Access Op. Req. Msg.), requesting/client computing node 110 may generate and send one or more fabric packets that includes a batch access operation request message to access one or more NVMe devices coupled with target host computing node 104. In some examples, as shown in FIG. 8, the fabric packets may be routed through fabric/network switch 114. The one or more fabric packets may be arranged or exchanged according to communication protocols including, but not limited to, Fibre Channel, InfiniBand, RoCE, iWARP or TCP communication protocols and/or according to the NVMeoF specification.

Moving to process 8.2 (Forward Fabric Packet), fabric/network switch 114 may forward the fabric packet to target host computing node 104.

Moving to process 8.3 (Forward Batch Access Op. Req. Msg.), logic and/or features at target host computing node 104 such as HFI/NIC 103 may process the fabric packet in order to de-encapsulate the batch access operation request message from the fabric packet and identify that this message is to be forwarded to NVMeoF controller 105 that controls access to the one or more NVMe devices 109 coupled with target host computing node 104. In some examples, the example fields of format 400 may be included in the batch access operation request message.

Moving to process 8.4 (ACK Msg. w/Batch ID), logic and/or features at NVMeoF controller 105 such as batch scheduler logic 222 may cause an ACK message to be sent to requesting/client computing node 110 to indicate that the requested batch access operation can be implemented. In some examples, the ACK message includes a batch ID assigned to the batch access operation (e.g., batch ID 501). Whether the requested batch access operation can be implemented may be based on whether batch NVMe device(s) 310 from among NVMe devices 109 can meet target metrics indicated in the batch access operation request message (e.g., a memory bandwidth target metric of 250 Mb/sec).

Moving to process 8.5 (Fabric Packet w/ACK Msg.), logic and/or features at target host computing node 104 such as HFI/NIC 103 may encapsulate the ACK message that includes the assigned batch ID in a fabric packet. In some examples, as shown in FIG. 8, the fabric packet that includes the ACK message may be routed through fabric/network switch 114.

Moving to process 8.6 (Forward Fabric Packet), fabric/network switch 114 may forward the fabric packet to requesting/client computing node 110.

Moving to process 8.7 (Fabric Packet(s) for Batch Access Op.), requesting/client computing node 110 may generate and send one or more fabric packets for the granted batch access operation that includes read/write transactions to be processed as part of the granted batch access operation. The read/write transactions may have a client ID, batch ID and a payload (if a write transaction). In some examples, as shown in FIG. 8, these fabric packets may be routed through fabric/network switch 114.

Moving to process 8.8 (Forward Fabric Packet(s)), fabric/network switch 114 may forward the one or more fabric packets to target host computing node 104.

Moving to process 8.9 (Forward Read/Write Transactions), logic and/or features at target host computing node 104 such as HFI/NIC 103 may process the one or more fabric packets in order to de-encapsulate read/write transactions from the one or more fabric packet and identify that these read/write transactions are to be forwarded to NVMeoF controller 105.

Moving to process 8.10 (Process Transaction Payloads), logic and/or features at NVMeoF controller 105 may process transaction payloads for the batch access operation granted to requesting/client computing node 110. In some examples, processing of the transaction payloads may include batch scheduling logic 222 scheduling read/write transaction for the batch access operation granted to requesting/client computing node 110 relative to other active and granted batch access operations. For example, batch management table 224 indicates that batch IDs 601 and 602 for respective requesting/client computing nodes 112 and 108 have higher priorities and thus may have read/write transactions schedule before read/write transactions from requesting/client computing node 110. Double arrows are shown in FIG. 8 to depict how write transactions may have payloads of data being written to batched NVMe device(s) 310 or read transaction may have payloads of data being read from batched NVMe device(s) 310.

Moving to process 8.11, (Telemetry Information), logic and/or features of NVMeoF controller 105 may gather telemetry information from batched NVMe device(s) 310 while read/write transactions for the granted batch access operation are being completed. In some examples, real-time metrics such as memory bandwidth or IOPs may be monitored or gathered during the granted batch access operation to determine whether target metrics for individual read/write transactions or for the granted batch access operation are being met. In some examples, telemetry information may be discovered/gathered from batched NVMe device(s) 310 by a bit-stream running by logic and/or features of NVMeoF controller 105 to perform dynamic and smart decisions depending on discovered/gathered telemetry information.

Moving to process 8.12, (Fabric Packet w/Batch Release Msg.), requesting/client computing node 110 may generate and send one or more fabric packets that includes a batch release message. In some examples, the batch release message includes the assigned batch ID (e.g., batch ID 501) to indicate that all read/write access requests for the batch access operation have been sent.

Moving to process 8.13 (Forward Fabric Packet), fabric/network switch 114 may forward the fabric packet to target host computing node 104.

Moving to process 8.14 (Fabric Packet with Batch Release Msg.), logic and/or features at target host computing node 104 such as HFI/NIC 103 may process the fabric packet in order to de-encapsulate the batch release message that includes the assigned batch ID in a fabric packet. and identify that this message is to be forwarded to NVMeoF controller 105. Process 800 may then come to an end.

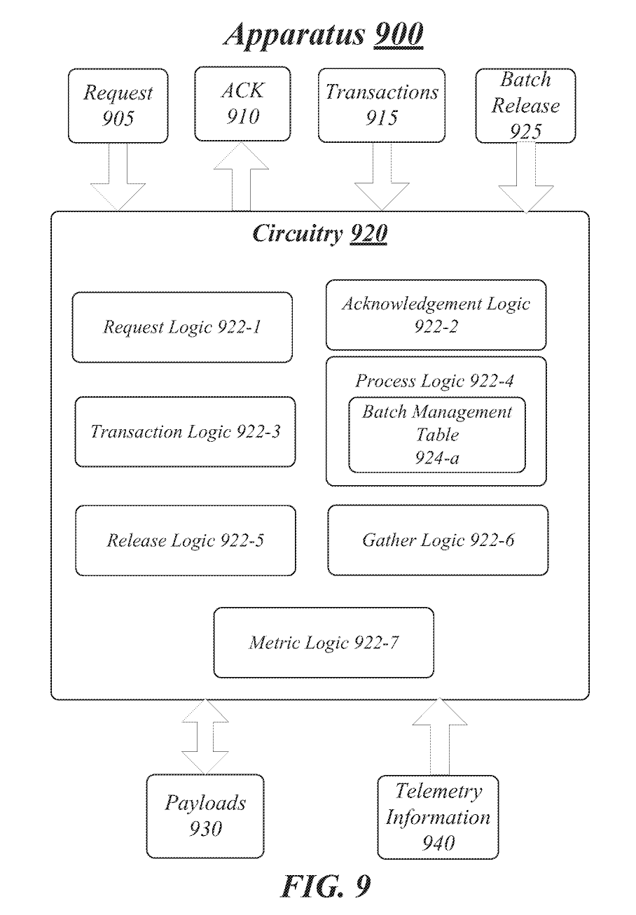

FIG. 9 illustrates an example block diagram for an apparatus 900. Although apparatus 900 shown in FIG. 9 has a limited number of elements in a certain topology, it may be appreciated that the apparatus 900 may include more or less elements in alternate topologies as desired for a given implementation.

According to some examples, apparatus 900 may be associated with a controller hosted by a target host computing node coupled with a networking fabric. For example, NVMeoF controller 105 as shown in FIGS. 1-3. Apparatus 900 may be supported by circuitry 920. For these examples, circuitry 920 may be incorporated within a processor, central processing unit (CPU), application specific integrated circuit (ASIC) or may include one or more field programmable gate arrays (FPGAs) maintained at a controller. Circuitry 920 may be arranged to execute one or more software, firmware or hardware implemented modules, components or logic 922-a (module, component or logic may be used interchangeably in this context). It is worthy to note that “a” and “b” and “c” and similar designators as used herein are intended to be variables representing any positive integer. Thus, for example, if an implementation sets a value for a=7, then a complete set of any combination of software, firmware or hardware for logic 922-a may include logic 922-1, 922-2, 922-3, 922-4, 922-5, 922-6 or 922-7. The examples presented are not limited in this context and the different variables used throughout may represent the same or different integer values. Also, “logic”, “module” or “component” may also include software/firmware stored in computer-readable media, and although the types of logic are shown in FIG. 9 as discrete boxes, this does not limit these components to storage in distinct computer-readable media components (e.g., a separate memory, etc.).

According to some examples, circuitry 920 may include a processor, processor circuit or processor circuitry. Circuitry 920 may be generally arranged to execute or implement one or more modules, components or logic 922-a. Circuitry 920 may be all or at least a portion of any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon®, Xeon Phi® and XScale® processors; and similar processors. According to some examples circuitry 920 may also include an ASIC and at least some logic 922-a may be implemented as hardware elements of the ASIC. According to some examples, circuitry 920 may also include an FPGA and at least some logic 922-a may be implemented as hardware elements of the FPGA.

According to some examples, apparatus 900 may include request logic 922-1. Request logic 922-1 may be executed or implemented by circuitry 920 to receive a batch access operation request to read data from or write data to at least one storage device of a plurality of storage devices coupled with a target host computing node that hosts the controller, the batch access operation request included in a fabric packet routed from a requesting computing node through a networking fabric coupled with the target host computing node. For these examples, the batch access operation request may be included in request 905. Request 905 may be pulled/extracted from the fabric packet by a communication interface (e.g., a host fabric interface) for the target host computing node and forwarded for receipt by request logic 922-1.

In some examples, apparatus 900 may include acknowledgement logic 922-2. acknowledgement logic 922-2 may be executed or implemented by circuitry 920 to cause an ACK message that includes an assigned batch identifier to be sent to the requesting computing node to indicate that the batch access operation has been granted. For these examples, the ACK message may be included in ACK 910.

According to some examples, apparatus 900 may include transaction logic 922-3. Transaction logic 922-3 may be executed or implemented by circuitry 920 to receive a plurality of transactions to read data from or write data to the at least one storage device for the granted batch access operation, separate transactions from among the plurality of transactions including the assigned batch identifier. For these examples, the plurality of transactions may be included in transactions 915.

In some examples, apparatus 900 may include process logic 922-4. Process logic 922-4 may be executed or implemented by circuitry 920 to process the plurality of transactions based on information included in the batch access operation request. For these examples, payloads 930 may include data read from or written to the at least one storage device while completing the plurality of transactions. In some examples, the plurality of transactions may be processed, at least in part, by scheduling each of the plurality of transactions according to information included in batch management table 924-a. Batch management table 924-a may be maintained by and/or accessible to process logic 922-4 in a data structure such as a look up table.

According to some examples, apparatus 900 may include release logic 922-5. Release logic 922-5 may be executed or implemented by circuitry 920 to receive a batch release message that includes the assigned batch identifier that was sent by the requesting computing node to indicate completion of the batch access operation responsive. For these examples, the batch release message may be included in batch release 925.

In some examples, apparatus 900 may include gather logic 922-6. Gather logic 922-6 may be executed or implemented by circuitry 920 to gather telemetry information while the plurality of transactions to read data from or write data to the at least one storage device are being completed. For these examples, the telemetry information may be included in telemetry information 940. Telemetry information 940 may include real-time measurements of memory bandwidth or IOPs for the at least one storage device being read from or written to while the plurality of transactions are being completed.

According to some examples, apparatus 900 may include metric logic 922-7. Metric logic 922-7 may be executed or implemented by circuitry 920 to determine whether the required memory bandwidth was met while the plurality of transactions to read data from or write data to the at least one storage device are being completed based on the gathered telemetry information. For these examples, a batch release message included in batch release 925 may include and indication to the requesting computing node of whether the required memory bandwidth was met.

Various components of apparatus 900 and a server or node implementing apparatus 900 may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

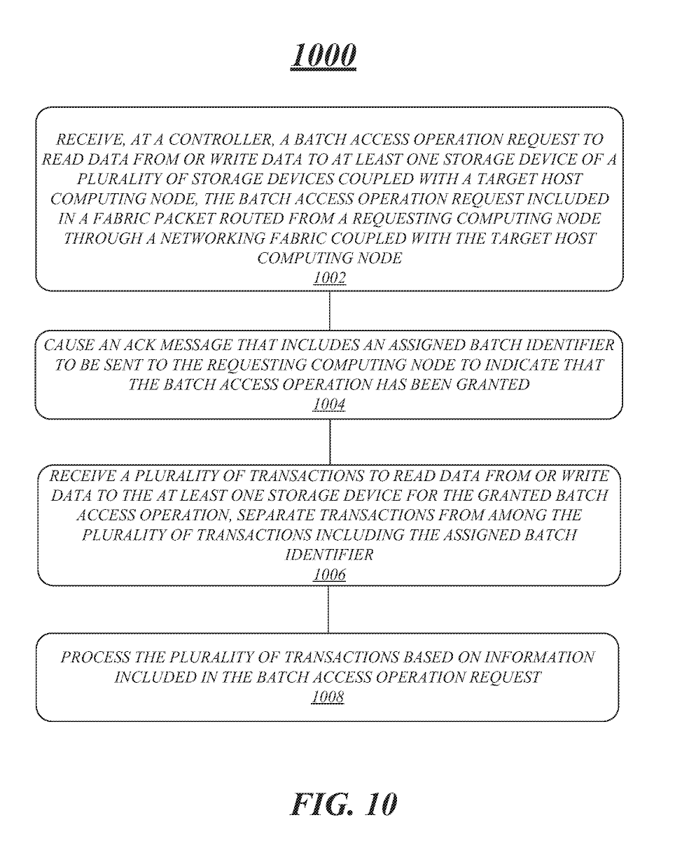

FIG. 10 illustrates an example of a logic flow 1000. Logic flow 1000 may be representative of some or all of the operations executed by one or more logic, features, or devices described herein, such as apparatus 1000. More particularly, logic flow 1000 may be implemented by at least request logic 922-1, acknowledgement logic 922-2, transaction logic 922-3 or process logic 922-4.

According to some examples, logic flow 1000 at block 1002 may receive, at a controller, a batch access operation request to read data from or write data to at least one storage device of a plurality of storage devices coupled with a target host computing node, the batch access operation request included in a fabric packet routed from a requesting computing node through a networking fabric coupled with the target host computing node. For these examples, request logic 922-1 may receive the batch access operation request.

In some examples, logic flow 1000 at block 1004 may cause an ACK message that includes an assigned batch identifier to be sent to the requesting computing node to indicate that the batch access operation has been granted. For these examples, acknowledgement logic 922-2 may cause the ACK message to be sent.

According to some examples, logic flow 1000 at block 1006 may receive a plurality of transactions to read data from or write data to the at least one storage device for the granted batch access operation, separate transactions from among the plurality of transactions including the assigned batch identifier. For these examples, transaction logic 922-3 may receive the plurality of transactions.

In some examples, logic flow 1000 at block 1008 may process the plurality of transactions based on information included in the batch access operation request. For these examples, process logic 922-4 may process the plurality of transactions.

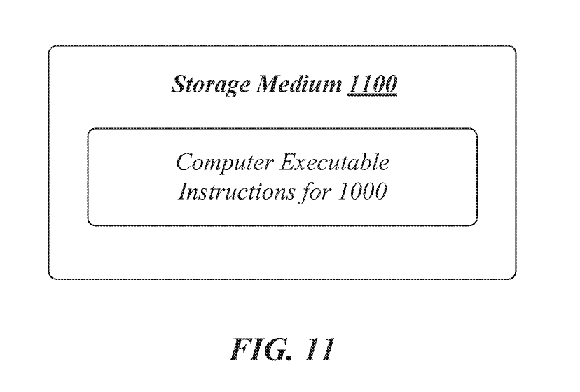

FIG. 11 illustrates an example of a storage medium 1100. Storage medium 1100 may comprise an article of manufacture. In some examples, storage medium 1100 may include any non-transitory computer readable medium or machine readable medium, such as an optical, magnetic or semiconductor storage. Storage medium 1100 may store various types of computer executable instructions, such as instructions to implement logic flow 1000. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

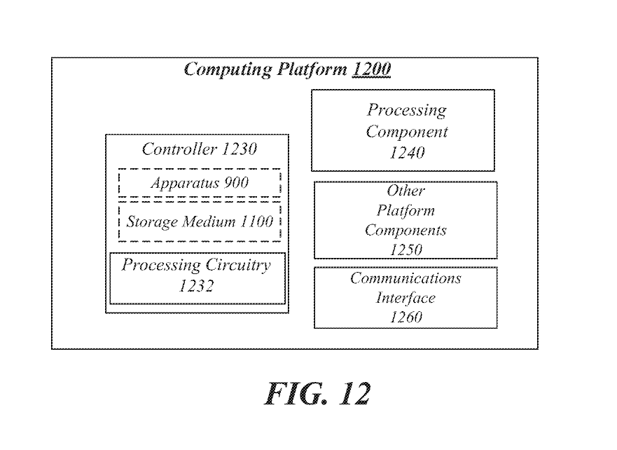

FIG. 12 illustrates an example computing platform 1200. In some examples, as shown in FIG. 12, computing platform 1200 may include a controller 1230, a processing component 1240, other platform components 1250 or a communications interface 1260. According to some examples, computing platform 1200 may be implemented in a target host computing node coupled to a networking fabric such as target host computing node 104 shown in FIG. 1.

According to some examples, controller 1230 may be similar to NVMeoF controller 105 of system 100 as shown in FIGS. 1-3. For these examples, logic and/or features resident at or located at controller 1230 may execute at least some processing operations or logic for apparatus 900 and may include storage media that includes storage medium 1100. Controller 1230 may include processing circuitry 1232. Processing circuity may include various hardware elements. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth.

According to some examples, processing component 1240 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, ASIC, PLD, DSP, FPGA/programmable logic, memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 1250 may include memory units, chipsets, controllers, peripherals, interfaces, oscillators, timing devices, video cards, audio cards, multimedia I/O components (e.g., digital displays), power supplies, and so forth. Examples of memory units associated with either other platform components 1250 or controller 1230 may include without limitation, various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, ferroelectric memory, SONOS memory, polymer memory such as ferroelectric polymer memory, FeTRAM or FeRAM, ovonic memory, single or multi-level PCM, nanowire, memristers, STT-MRAM, magnetic or optical cards, an array of devices such as Redundant Array of Independent Disks (RAID) drives, solid state memory devices, solid state drives (SSDs), hard disk drives (HDDs) or any other type of storage media suitable for storing information.

In some examples, communications interface 1260 may include logic and/or features to support a communication interface. For these examples, communications interface 1260 may include one or more communication interfaces that operate according to various communication protocols or standards to communicate over direct or network communication links. Direct communications may occur through a direct interface via use of communication protocols or standards described in one or more industry standards (including progenies and variants) such as those associated with the SMBus specification, the PCIe specification, the NVMe base specification, the SATA specification, SAS specification or the USB specification. Network communications may occur through a network interface via use of communication protocols or standards such as those described in one or more Ethernet standards promulgated by the IEEE. For example, one such Ethernet standard may include IEEE 802.3-2012, Carrier sense Multiple access with Collision Detection (CSMA/CD) Access Method and Physical Layer Specifications, Published in December 2012 (hereinafter “IEEE 802.3”). Network communication may also occur according to one or more OpenFlow specifications such as the OpenFlow Hardware Abstraction API Specification. Network communication may also occur over fabric links coupled with computing platform 1200 according to the NVMeoF specification, or using one or more of Fibre Channel communication protocols, InfiniBand communication protocols, RoCE communication protocols, iWARP communication protocols or TCP communication protocols.

As mentioned above computing platform 1200 may be implemented in a target host computing node coupled to a networking fabric. Accordingly, functions and/or specific configurations of computing platform 1200 described herein, may be included or omitted in various embodiments of computing platform 1200, as suitably desired for a computing node coupled to a networking fabric.

The components and features of computing platform 1200 may be implemented using any combination of discrete circuitry, ASICs, logic gates and/or single chip architectures. Further, the features of computing platform 1200 may be implemented using microcontrollers, programmable logic arrays and/or microprocessors or any combination of the foregoing where suitably appropriate. It is noted that hardware, firmware and/or software elements may be collectively or individually referred to herein as “logic”, “circuit” or “circuitry.”

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The follow examples pertain to additional examples of technologies disclosed herein.

Example 1. An example controller may include circuitry logic for execution by the circuitry. The logic may receive a batch access operation request to read data from or write data to at least one storage device of a plurality of storage devices coupled with a target host computing node that hosts the controller. The batch access operation request may be included in a fabric packet routed from a requesting computing node through a networking fabric coupled with the target host computing node. The logic may also cause an ACK message that includes an assigned batch identifier to be sent to the requesting computing node to indicate that the batch access operation has been granted. The logic may also receive a plurality of transactions to read data from or write data to the at least one storage device for the granted batch access operation, separate transactions from among the plurality of transactions including the assigned batch identifier. The logic may also process the plurality of transactions based on information included in the batch access operation request.

Example 2. The controller of example 1, the logic may also receive a batch release message that includes the assigned batch identifier sent from the requesting computing node to indicate completion of the granted batch access operation.

Example 3. The controller of example 1, the batch operation request may include one or more of target metric information, priority information or an access pattern for reading from or writing to the at least one storage device.

Example 4. The controller of example 3, the logic to process the plurality of transactions may include the logic to schedule the plurality of transaction based on the priority information. The priority information indicates a relative priority for the batch access operation request compared to other batch access operation requests sent by the same requesting computing node or other requesting computing nodes coupled with the target host computing node through the networking fabric.

Example 5. The controller of example 3, the target metric information may indicate a required memory bandwidth to read data from or write data to the at least one storage device. For these examples, the logic may also cause the ACK message to be sent to the requesting computing node based on the at least one storage device having adequate available memory bandwidth to meet the target metric.

Example 6. The controller of example 3, the target metric information to indicate a required memory bandwidth to read data from or write data to the at least one storage device. For these examples, the logic may also gather telemetry information while the plurality of transactions to read data from or write data to the at least one storage device are being completed. The logic may also determine whether the required memory bandwidth was met while the plurality of transactions to read data from or write data to the at least one storage device are being completed based on the gathered telemetry information.

Example 7. The controller of example 1, the plurality of storage devices may be arranged to operate according to one or more NVMe Base Specifications including the NVMe Base Specification, revision 1.3.

Example 8. The controller of example 7, the controller arranged to operate according to the one or more NVMe Base Specifications including the NVMe Base Specification, revision 1.3 and according to one or more NVMeoF Specifications including the NVMeoF Specification, revision 1.0.

Example 9. The controller of example 8, the batch access operation request included in the fabric packet may be arranged according to the one or more NVMeoF Specifications including the NVMeoF Specification, revision 1.0.

Example 10. The controller of example 9, the networking fabric may be arranged to operate using Fibre Channel communication protocols, InfiniBand communication protocols, RoCE communication protocols, iWARP communication protocols or TCP communication protocols.

Example 11. The controller of example 1 may include one or more of a command bus coupled to the circuitry, one or more processors coupled to the command bus, and a host fabric interface communicatively coupled to the circuitry.

Example 12. An example method may include receiving, at a controller, a batch access operation request to read data from or write data to at least one storage device of a plurality of storage devices coupled with a target host computing node. The batch access operation request may be included in a fabric packet routed from a requesting computing node through a networking fabric coupled with the target host computing node. The method may also include causing an ACK message that includes an assigned batch identifier to be sent to the requesting computing node to indicate that the batch access operation has been granted. The method may also include receiving a plurality of transactions to read data from or write data to the at least one storage device for the granted batch access operation, separate transactions from among the plurality of transactions including the assigned batch identifier. The method may also include processing the plurality of transactions based on information included in the batch access operation request.

Example 13. The method of example 12 may also include receiving a batch release message that includes the assigned batch identifier sent from the requesting computing node to indicate completion of the granted batch access operation.

Example 14. The method of example 12, the batch operation request may include one or more of target metric information, priority information or an access pattern for reading from or writing to the at least one storage device.

Example 15. The method of example 14, processing the plurality of transactions may include scheduling the plurality of transaction based on the priority information. For these examples, the priority information may indicate a relative priority for the batch access operation request compared to other batch access operation requests sent by the same requesting computing node or other requesting computing nodes coupled with the target host computing node through the networking fabric.

Example 16. The method of example 14 may also include the target metric information indicating a required memory bandwidth for reading data from or writing data to the at least one storage device. The method may also include causing the ACK message to be sent to the requesting computing node based on the at least one storage device having adequate available memory bandwidth to meet the target metric.

Example 17. The method of example 14 may also include the target metric information indicating a required memory bandwidth for reading data from or writing data to the at least one storage device. The method may also include gathering telemetry information while the plurality of transactions to read data from or write data to the at least one storage device are being completed. The method may also include determining whether the required memory bandwidth was met while the plurality of transactions to read data from or write data to the at least one storage device are being completed based on the gathered telemetry information.

Example 18. The method of example 12, the plurality of storage devices may be arranged to operate according to one or more NVMe Base Specifications including the NVMe Base Specification, revision 1.3.

Example 19. The method of example 18, the controller may be arranged to operate according to the one or more NVMe Base Specifications including the NVMe Base Specification, revision 1.3 and according to one or more NVMeoF Specifications including the NVMeoF Specification, revision 1.0.

Example 20. The method of example 20, the batch access operation request may be included in the fabric packet is arranged according to the one or more NVMeoF Specifications including the NVMeoF Specification, revision 1.0.

Example 21. The method of example 20, the networking fabric may be arranged to operate using Fibre Channel communication protocols, InfiniBand communication protocols, RoCE communication protocols, iWARP communication protocols or TCP communication protocols.

Example 22. An example at least one machine readable medium may include a plurality of instructions that in response to being executed by a system may cause the system to carry out a method according to any one of examples 12 to 21.

Example 23. An example apparatus may include means for performing the methods of any one of examples 12 to 21.

Example 24. An example at least one machine readable medium may include a plurality of instructions that in response to being executed by a controller may cause the controller to receive a batch access operation request to read data from or write data to at least one storage device of a plurality of storage devices coupled with a target host computing node that hosts the controller. The batch access operation request included in a fabric packet routed from a requesting computing node through a networking fabric coupled with the target host computing node. The instructions may also cause the controller to cause an ACK message that includes an assigned batch identifier to be sentto the requesting computing node to indicate that the batch access operation has been granted. The instructions may also cause the controller to receive a plurality of transactions to read data from or write data to the at least one storage device for the granted batch access operation, separate transactions from among the plurality of transactions including the assigned batch identifier. The instructions may also cause the controller to process the plurality of transactions based on information included in the batch access operation request.

Example 25. The at least one machine readable medium of example 24, the instructions may also cause the controller to receive a batch release message that includes the assigned batch identifier sent from the requesting computing node to indicate completion of the granted batch access operation.

Example 26. The at least one machine readable medium of example 24, the batch operation request may include one or more of target metric information, priority information or an access pattern for reading from or writing to the at least one storage device.

Example 27. The at least one machine readable medium of example 26, the instructions may also cause the controller to schedule the plurality of transaction based on the priority information. For these examples, the priority information may indicate a relative priority for the batch access operation request compared to other batch access operation requests sent by the same requesting computing node or other requesting computing nodes coupled with the target host computing node through the networking fabric.

Example 28. The at least one machine readable medium of example 26, the target metric information may indicate a required memory bandwidth to read data from or write data to the at least one storage device. For these examples, the instructions may also cause the controller to cause the ACK message to be sent to the requesting computing node based on the at least one storage device having adequate available memory bandwidth to meet the target metric.

Example 29. The at least one machine readable medium of example 26, the target metric information may indicate a required memory bandwidth to read data from or write data to the at least one storage device. For these examples, the instructions may also cause the controller to gather telemetry information while the plurality of transactions to read data from or write data to the at least one storage device are being completed. The instructions may also cause the controller to determine whether the required memory bandwidth was met while the plurality of transactions to read data from or write data to the at least one storage device are being completed based on the gathered telemetry information.

Example 30. The at least one machine readable medium of example 24, the plurality of storage devices may be arranged to operate according to one or more NVMe Base Specifications including the NVMe Base Specification, revision 1.3.

Example 31. The at least one machine readable medium of example 30, the controller may be arranged to operate according to the one or more NVMe Base Specifications including the NVMe Base Specification, revision 1.3 and according to one or more NVMeoF Specifications including the NVMeoF Specification, revision 1.0.

Example 32. The at least one machine readable medium of example 31, the batch access operation request included in the fabric packet may be arranged according to the one or more NVMeoF Specifications including the NVMeoF Specification, revision 1.0.

Example 33. The at least one machine readable medium of example 32, the networking fabric may be arranged to operate using Fibre Channel communication protocols, InfiniBand communication protocols, RoCE communication protocols, iWARP communication protocols or TCP communication protocols.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A controller comprising:
circuitry; and
logic for execution by the circuitry to:
receive a batch access operation request to read data from or write data to at least one storage device of a plurality of storage devices coupled with a target host computing node that hosts the controller, the batch access operation request included in a fabric packet routed from a requesting computing node through a networking fabric coupled with the target host computing node;
cause an acknowledgement (ACK) message that includes an assigned batch identifier to be sent to the requesting computing node to indicate that the batch access operation has been granted;
receive a plurality of transactions to read data from or write data to the at least one storage device for the granted batch access operation, separate transactions from among the plurality of transactions including the assigned batch identifier; and
process the plurality of transactions based on information included in the batch access operation request.

2. The controller of claim 1, further comprising the logic to:
receive a batch release message that includes the assigned batch identifier sent from the requesting computing node to indicate completion of the granted batch access operation.

3. The controller of claim 1, comprising the batch operation request to include one or more of target metric information, priority information or an access pattern for reading from or writing to the at least one storage device.

4. The controller of claim 3, the logic to process the plurality of transactions further comprises the logic to:
schedule the plurality of transaction based on the priority information, wherein the priority information indicates a relative priority for the batch access operation request compared to other batch access operation requests sent by the same requesting computing node or other requesting computing nodes coupled with the target host computing node through the networking fabric.

5. The controller of claim 3, comprising the target metric information to indicate a required memory bandwidth to read data from or write data to the at least one storage device, the logic to:
cause the ACK message to be sent to the requesting computing node based on the at least one storage device having adequate available memory bandwidth to meet the target metric.

6. The controller of claim 3, comprising the target metric information to indicate a required memory bandwidth to read data from or write data to the at least one storage device, the logic to:
gather telemetry information while the plurality of transactions to read data from or write data to the at least one storage device are being completed; and
determine whether the required memory bandwidth was met while the plurality of transactions to read data from or write data to the at least one storage device are being completed based on the gathered telemetry information.

7. The controller of claim 1, comprising the plurality of storage devices arranged to operate according to one or more Non-Volatile Memory Express (NVMe) Base Specifications including the NVMe Base Specification, revision 1.3.

8. The controller of claim 7, comprising the controller arranged to operate according to the one or more NVMe Base Specifications including the NVMe Base Specification, revision 1.3 and according to one or more NVM Express over Fabrics (NVMeoF) Specifications including the NVMeoF Specification, revision 1.0.

9. The controller of claim 8, comprising the batch access operation request included in the fabric packet is arranged according to the one or more NVMeoF Specifications including the NVMeoF Specification, revision 1.0.

10. The controller of claim 9, comprising the networking fabric arranged to operate using Fibre Channel communication protocols, InfiniBand communication protocols, Remote Direct Memory Access (RDMA) over Converged Ethernet (RoCE) communication protocols, Internet Wide Area RDMA Protocol (iWARP) communication protocols or transmission control protocol (TCP) communication protocols.

11. The controller of claim 1, comprising one or more of:
a command bus coupled to the circuitry;
one or more processors coupled to the command bus; and
a host fabric interface communicatively coupled to the circuitry.

12. A method comprising:
receiving, at a controller, a batch access operation request to read data from or write data to at least one storage device of a plurality of storage devices coupled with a target host computing node, the batch access operation request included in a fabric packet routed from a requesting computing node through a networking fabric coupled with the target host computing node;
causing an acknowledgement (ACK) message that includes an assigned batch identifier to be sent to the requesting computing node to indicate that the batch access operation has been granted;
receiving a plurality of transactions to read data from or write data to the at least one storage device for the granted batch access operation, separate transactions from among the plurality of transactions including the assigned batch identifier; and
processing the plurality of transactions based on information included in the batch access operation request.

13. The method of claim 12, comprising:
receiving a batch release message that includes the assigned batch identifier sent from the requesting computing node to indicate completion of the granted batch access operation.

14. The method of claim 12, comprising the batch operation request including one or more of target metric information, priority information or an access pattern for reading from or writing to the at least one storage device.

15. The method of claim 14, processing the plurality of transactions comprises scheduling the plurality of transaction based on the priority information, wherein the priority information indicates a relative priority for the batch access operation request compared to other batch access operation requests sent by the same requesting computing node or other requesting computing nodes coupled with the target host computing node through the networking fabric.

16. The method of claim 14, comprising:
the target metric information indicating a required memory bandwidth for reading data from or writing data to the at least one storage device; and
causing the ACK message to be sent to the requesting computing node based on the at least one storage device having adequate available memory bandwidth to meet the target metric.

17. The method of claim 14, comprising:
the target metric information indicating a required memory bandwidth for reading data from or writing data to the at least one storage device;
gathering telemetry information while the plurality of transactions to read data from or write data to the at least one storage device are being completed; and
determining whether the required memory bandwidth was met while the plurality of transactions to read data from or write data to the at least one storage device are being completed based on the gathered telemetry information.

18. The method of claim 12, comprising:
the plurality of storage devices arranged to operate according to one or more Non-Volatile Memory Express (NVMe) Base Specifications including the NVMe Base Specification, revision 1.3;
the controller arranged to operate according to the one or more NVMe Base Specifications including the NVMe Base Specification, revision 1.3 and according to one or more NVM Express over Fabrics (NVMeoF) Specifications including the NVMeoF Specification, revision 1.0;
the batch access operation request included in the fabric packet is arranged according to the one or more NVMeoF Specifications including the NVMeoF Specification, revision 1.0; and
the networking fabric arranged to operate using Fibre Channel communication protocols, InfiniBand communication protocols, Remote Direct Memory Access (RDMA) over Converged Ethernet (RoCE) communication protocols, Internet Wide Area RDMA Protocol (iWARP) communication protocols or transmission control protocol (TCP) communication protocols.

19. At least one machine readable medium comprising a plurality of instructions that in response to being executed by a controller cause the controller to:
receive a batch access operation request to read data from or write data to at least one storage device of a plurality of storage devices coupled with a target host computing node that hosts the controller, the batch access operation request included in a fabric packet routed from a requesting computing node through a networking fabric coupled with the target host computing node;
cause an acknowledgement (ACK) message that includes an assigned batch identifier to be sent to the requesting computing node to indicate that the batch access operation has been granted;
receive a plurality of transactions to read data from or write data to the at least one storage device for the granted batch access operation, separate transactions from among the plurality of transactions including the assigned batch identifier; and
process the plurality of transactions based on information included in the batch access operation request.

20. The at least one machine readable medium of claim 19, further comprising the instructions to cause the controller to:
receive a batch release message that includes the assigned batch identifier sent from the requesting computing node to indicate completion of the granted batch access operation.

21. The at least one machine readable medium of claim 19, comprising the batch operation request to include one or more of target metric information, priority information or an access pattern for reading from or writing to the at least one storage device.

22. The at least one machine readable medium of claim 21, further comprising the instructions to cause the controller to:
schedule the plurality of transaction based on the priority information, wherein the priority information indicates a relative priority for the batch access operation request compared to other batch access operation requests sent by the same requesting computing node or other requesting computing nodes coupled with the target host computing node through the networking fabric.

23. The at least one machine readable medium of claim 21, comprising the target metric information to indicate a required memory bandwidth to read data from or write data to the at least one storage device, the instructions to further cause the controller to:
cause the ACK message to be sent to the requesting computing node based on the at least one storage device having adequate available memory bandwidth to meet the target metric.

24. The at least one machine readable medium of claim 21, comprising the target metric information to indicate a required memory bandwidth to read data from or write data to the at least one storage device, the instructions to further cause the controller to:
gather telemetry information while the plurality of transactions to read data from or write data to the at least one storage device are being completed; and
determine whether the required memory bandwidth was met while the plurality of transactions to read data from or write data to the at least one storage device are being completed based on the gathered telemetry information.

25. The at least one machine readable medium of claim 19, comprising:
the plurality of storage devices arranged to operate according to one or more Non-Volatile Memory Express (NVMe) Base Specifications including the NVMe Base Specification, revision 1.3;
the controller arranged to operate according to the one or more NVMe Base Specifications including the NVMe Base Specification, revision 1.3 and according to one or more NVM Express over Fabrics (NVMeoF) Specifications including the NVMeoF Specification, revision 1.0;
the batch access operation request included in the fabric packet is arranged according to the one or more NVMeoF Specifications including the NVMeoF Specification, revision 1.0; and
the networking fabric arranged to operate using Fibre Channel communication protocols, InfiniBand communication protocols, Remote Direct Memory Access (RDMA) over Converged Ethernet (RoCE) communication protocols, Internet Wide Area RDMA Protocol (iWARP) communication protocols or transmission control protocol (TCP) communication protocols.
